(19) United States
(12) Patent Application Publication
(10) Pub. No.: US 2002/0149520 A1
(43) Pub. Date: Oct. 17, 2002

(54) Microstrip antenna with improved low angle performance

(76) Inventors: Thomas S. Laubner, Merrimac, MA (US); Robert Schilling, Londonderry, NH (US)

Correspondence Address: Tyco Technology Resources, Suite 450, 4550 New Linden Hill Road, Wilmington, DE, 19808-2952, US

(21) Appl. No.: 09/966,221

(22) Filed: Sep. 28, 2001

Related U.S. Application Data
(60) Provisional application No. 60/283,468, filed on Apr. 12, 2001.

(51) Int. Cl. H01Q 1/38; H01Q 1/48

(52) U.S. Cl. 343/700 MS; 343/846

(57) ABSTRACT

A microstrip antenna capable of providing high radiation gain both at the zenith and at low angles. The microstrip antenna includes a raised ground plane disposed on a flat ground plane, a dielectric substrate disposed on the raised ground plane, a patch disposed on the dielectric substrate, a feed pin disposed through the patch, the dielectric substrate and the raised ground plane, and a dielectric lens for encapsulating at least a portion of the patch to increase the radiation gain at low angles.

### RELATED APPLICATION

The present application claims the benefit of priority based on U.S. Provisional Application No. 60/283,468, filed on Apr. 12, 2001, assigned to the same assignee as the present invention, and entitled “Microstrip Antenna with Improved Low Angle Performance”, which is herein fully incorporated by reference.

### FIELD OF THE INVENTION

The present invention relates to microstrip antennas and more particularly, to a microstrip antenna capable of providing high radiation gain at the zenith as well as at low angles close to the horizon.

### BACKGROUND OF THE INVENTION

Microstrip antennas offer advantages that may not be realized by pole-type antennas. Since microstrip antennas typically utilize patches of conductive layers to transmit and receive electromagnetic waves, they have a low profile (height), can be manufactured easily, and are compatible with electronic devices that utilize microstrip configurations.

FIG. 1A is a plan view of a conventional microstrip antenna 50 and FIG. 1B is a cross-sectional view of the antenna 50 cut along line 1B-1B of FIG. 1A. As shown in FIGS. 1A and 1B, a conventional microstrip antenna 50 includes a flat “ground” plane 10, a dielectric substrate 11 disposed on the ground plane 10, an antenna element or “patch” 12 disposed on the dielectric substrate 11, and at least one feed pin 14 disposed in a hole defined through the patch 12, the dielectric substrate 1 1 and the ground plane 10. The ground plane 10 is a conductive layer that can be formed with, for example, copper or aluminum. The patch 12 is a thin conductive layer that can be formed with any conductive material such as copper. The antenna 50 is used to receive electromagnetic waves from transmitters (e.g., satellites, terrestrial base stations) and feed them to a receiver through the feed pin and/or to radiate electromagnetic waves according to signals received from a transmitter through the feed pin 14 so that they can be received by other receivers. The bottom end of the feed pin 14 which passes through the ground plane 10 is electrically connected to electronic devices such as amplifiers, filters, modulators, etc., that are typically required in conjunction with the antenna for transmission and/or reception in a radio communication system.

Although conventional microstrip patch antennas such as the antenna 50 are relatively receptive of signals transmitted from locations at or near the zenith (i.e., 90 degrees from the horizon), these antennas are much less receptive of signals transmitted from locations at or near low angles (e.g., 10-30 degrees from the horizon). However, in many applications, it is desired to have an antenna that is receptive both at the zenith and at low angles. For instance, in systems such as GPS (Global Positioning System) and SDARS (Satellite Digital Audio Radio System), an antenna may need to communicate with transmitters at both high and low elevation angles. Therefore, the conventional microstrip patch antennas are not suitable for use in applications requiring high gain at the zenith and at low angles.

Accordingly, there is a need for an improved microstrip antenna that is capable of providing high gain both at the zenith and at low angles without compromising its low profile advantage, so that the microstrip antenna can transmit and receive signals to and from such locations.

### SUMMARY OF THE INVENTION

The present invention provides an improved microstrip antenna capable of providing high gain both at the zenith and at low angles, which overcomes the problems associated with conventional microstrip antennas. Particularly, the microstrip antenna of the present invention includes a dielectric lens fully or partially encapsulating the patch of the antenna, and a raised ground plane supporting the patch above a flat ground plane. The dielectric lens refracts electromagnetic waves directed to and from the patch so as to increase the radiation gain at low angles (e.g., less than 30 degrees from the horizon). The raised ground plane further enhances the refraction effect, thereby further increasing the radiation gain at the low angles. As a result, the microstrip antenna of the present invention provides an increased gain at the low angles as well as providing high gain at the zenith.

Accordingly, the present invention is directed to a microstrip antenna including a conductive ground plane, a dielectric substrate disposed on the ground plane, a patch disposed on the dielectric substrate, feed means for electrically feeding the patch, and a dielectric lens for encapsulating at least a portion of the patch to increase radiation gain at low angles.

### BRIEF DESCRIPTION OF THE DRAWINGS

FIG. 1A is a plan view of a conventional microstrip antenna.

FIG. 1B is a cross-sectional view of the conventional microstrip antenna cut along line 1B-1B of FIG. 1A.

FIG. 2A is a plan view of a microstrip antenna according to a first embodiment of the present invention.

FIG. 2B is a cross-sectional view of the microstrip antenna cut along line 2B-2B of FIG. 2A.

FIG. 3 is a sectional view of a microstrip antenna according to a second embodiment of the present invention.

FIG. 4 is a sectional view of a microstrip antenna according to a third embodiment of the present invention.

FIGS. 5A and 5B are graphs illustrating exemplary radiation patterns of the conventional microstrip antenna of FIG. 1.

FIGS. 6A and 6B are graphs illustrating exemplary radiation patterns of the microstrip antenna of FIG. 2A according to the present invention.

### DETAILED DESCRIPTION OF THE PREFERRED EMBODIMENTS

In the drawings, the same reference numerals are used to indicate the same elements.

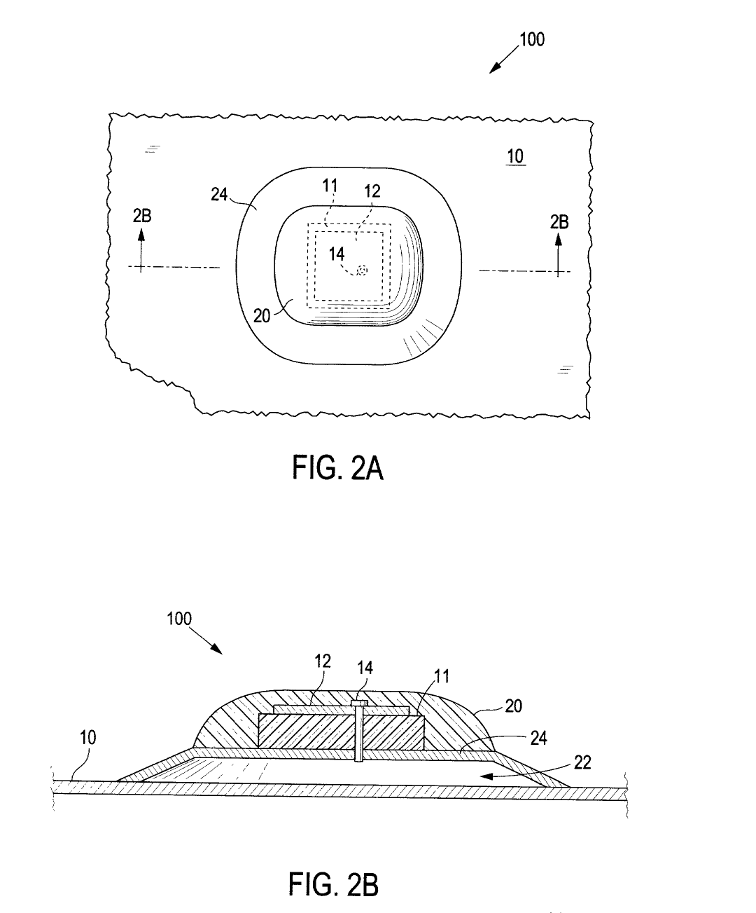

FIG. 2A is a plan view of an exemplary microstrip antenna 100 according to a first embodiment of the present invention, and FIG. 2B is a cross-sectional view of the microstrip antenna 100 cut along line 2B-2B of FIG. 2A. As shown in FIGS. 2A and 2B, the microstrip antenna 100 includes a flat ground plane 10, a raised ground plane 24 disposed on the flat ground plane 10, a dielectric substrate 11 disposed on the raised ground plane 24, a patch 12 disposed on the dielectric substrate 11, at least one feed pin 14, and a dielectric lens 20 fully encapsulating the patch 12 and the dielectric substrate 11.

The feed pin 14 is disposed in a hole defined through the patch 12, the dielectric substrate 11 and the raised ground plane 24. As an alternative to the feed pin 14, any other mechanism for feeding the patch 12 can be used. The raised ground plane 24 is a conductive substrate formed with a conductive material such as copper, aluminum, etc. The dielectric lens 20 can be formed of any dielectric material known in the art, such as plastics, fiberglass, etc.

Due to the operation of the dielectric lens 20 in conjunction with the raised ground plane 24, the microstrip antenna 100 of the present invention provides high receptivity or radiation gain both at the zenith (90° from the horizon) and at low angles (e.g., less than 45° from the horizon). Particularly, the dielectric lens 20 functions to refract electromagnetic waves transmitted or received by the patch 12. This causes more electromagnetic waves to be received or transmitted by the patch 12 at the low angles (i.e., in the direction of low angles) because of the refracted electromagnetic waves. The raised ground plane 24 further enhances this effect by raising the patch 12 and the dielectric substrate 11 above the flat ground plane 10 so that more downward refraction of electromagnetic waves can occur. The raised ground plane 24 also functions as a coupler to the flat ground plane 10.

The raised ground plane 24 can be formed such that there is a void or space 22 between the flat ground plane 10 and the raised ground plane 24. Electronics and other circuitry typically required for the proper operation of the antenna, such as amplifiers, filters, cables, etc., can be disposed in optional space 22. As a result, a more compact and space-efficient microstrip antenna can be provided.

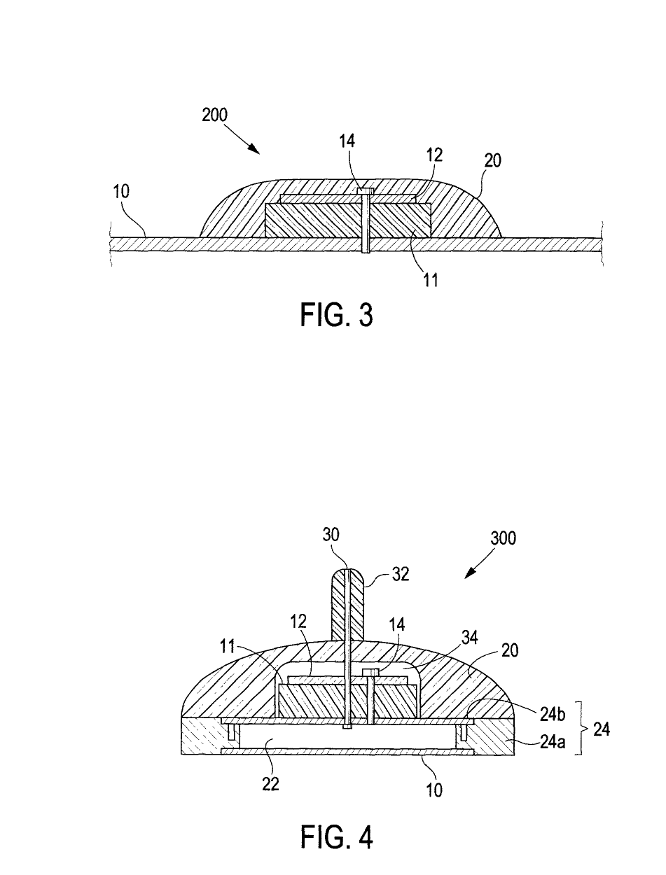

FIG. 3 is an example of a sectional view of a microstrip antenna 200 according to a second embodiment of the present invention. As shown in FIG. 3, the microstrip antenna 200 is identical to the microstrip antenna 100 shown in FIGS. 2A and 2B, except for the absence of the raised ground plane 24 in the microstrip antenna 200. That is, the dielectric substrate 11 and the dielectric lens 20 are disposed directly on the flat ground plane 10. As discussed above, the dielectric lens 20 functions to refract electromagnetic waves such that high gain is achieved both at the zenith and at low angles. Although the low angle gain for the microstrip antenna 200 may not be as high as the low angle gain offered by the microstrip antenna 100, this gain will still be higher than the low angle gain offered by conventional microstrip antennas without the dielectric lens.

In accordance with other embodiments, in addition to the components of the microstrip antenna discussed above, the microstrip antenna can include additional layers of patches and dielectric substrates stacked on top of each other, or can include other types of antenna elements (e.g., monopole, dipole, etc.) that are known in the art. FIG. 4 is an example of a sectional view of a microstrip antenna 300 having an additional antenna element according to a third embodiment of the invention. As shown in FIG. 4, the microstrip antenna 300 includes a flat ground plane 10, a raised ground plane 24 composed of first and second parts 24a, 24b, a dielectric substrate 11 disposed on the raised ground plane 24, a patch 12 disposed on the dielectric substrate 11, a feed pin 14 disposed through the patch 12, the dielectric substrate 11 and the raised ground plane 24, and a dielectric lens 20 covering the patch 12 and the dielectric substrate 11 with an air gap 34 provided therebetween.

The microstrip antenna 300 further includes an additional monopole antenna element 30 and a dielectric cap 32. The monopole 30 is disposed through the raised ground plane 24, the dielectric substrate 11, the patch 12, and the dielectric lens 20, and projects from the lens 20. The dielectric cap 32 surrounds the monopole 30. The monopole 30 and the cap 32 are conventional elements that are known in the antenna art, e.g., for use in cellular or mobile phones. The air gap 34, which is optionally provided herein, is also known in the art and is typically provided to enhance the manufacturing process of the antenna.

The raised ground plane 24 in this embodiment is divided into first and second parts 24a and 24b. For instance, as noted above, circuitry, such as a preamplifier circuit for the antenna, can be disposed in the air gap 22. In such an embodiment, portion 24b may comprise a printed circuit board (PCB) mounted with its ground plane face up and the circuitry side face down in gap 22. Portion 24a is essentially similar to raised ground plane 24 as described in connection with FIGS. 2A and 2B and may be a conductive substrate formed with a conductive material such as copper, aluminum, etc.

Raised ground plane 24 may comprise any number of portions and any number of materials. Essentially all that is required of raised ground plane 24 is that it can serve as an electrical ground plane and can be formed on top of the flat ground plane 10. The first and second parts 24a and 24b are just examples for illustrating how the raised ground plane 24 can have different shapes, sizes and configurations as long as it is coupled to the flat ground plane 10 and raises the patch 12 above the flat ground plane 10. Other examples are possible and contemplated as part of the present invention. FIG. 4 also illustrates another aspect of the invention that can vary from embodiment to embodiment. Specifically, in the FIG. 4 embodiment, flat ground plane 10 is approximately the same size as raised ground plane portion 24b and smaller that raised ground plane portion 24a. The relative size of the flat ground plane to the raised ground plane is virtually limitless.

Further, lens 20 and dielectric cap 32 may be formed integrally with each other, such has by a single-piece molding.

Since the microstrip antenna 300 includes therein both the patch 12 and the monopole 30, it is a dual function antenna package optimized to transmit and receive in two separate frequency bands and, thus, can be used in connection with two communication systems, e.g., GPS (Global Positioning Satellite, which operates at 1575 MHz) and PCS (Personal Communication System, which operates at 1850-1990 MHz).

In all these embodiments of the present invention, the dielectric lens 20 is shown as fully covering the patch 12 and the dielectric substrate 11. However, it is equally possible, if desired, to have the dielectric lens 20 cover or encapsulate only a portion of the patch 12 and/or dielectric substrate 11. In such cases, the low angle gain may not be as high as the low angle gain achieved by the full encapsulation embodiment; nevertheless, that gain will still be higher than the low angle gain achieved by prior art microstrip antennas without any dielectric lens.

Furthermore, one skilled in the art will readily understand that any number of shapes, sizes or configurations of the dielectric lens 20 are possible. The height of the raised ground plane 24 as well as the refractive index, material, shape, size and configuration of the dielectric lens 20 can be varied to control the gain at the zenith and low angles, so that desired performance characteristics can be achieved by the microstrip antennas of the present invention. Moreover, different shapes, sizes and configurations for the patch 12, the dielectric substrate 11, and the raised ground plane 24 are also contemplated as part of this invention.

Also, in the microstrip antennas of the present invention, an air gap may be provided between the dielectric lens and the patch, such as the air gap 34 shown in FIG. 4, to facilitate the manufacturing process of the antennas, if desired. For instance, air has a lower dielectric constant than most, if not all, of the materials out of which lens 20 is likely to be formed. Therefore, incorporation of an air gap can enhance manufacturability of the device. As is well known in the art, it typically is much easier to control the dielectric load with an air gap than with a solid heavy dielectric such as lens 20.

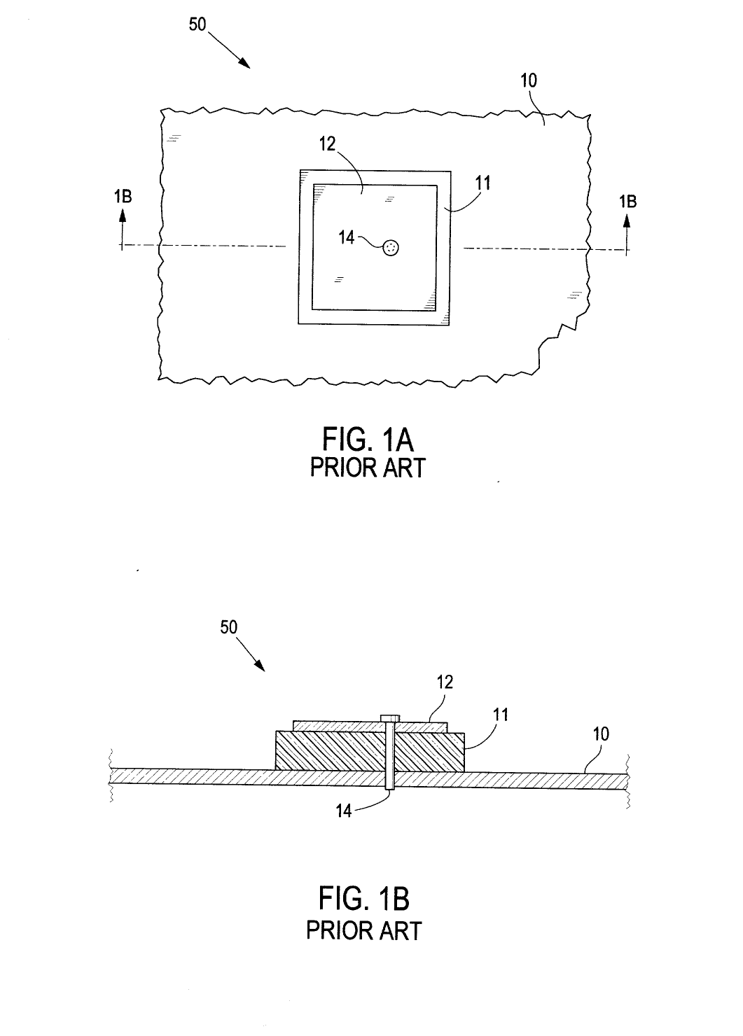

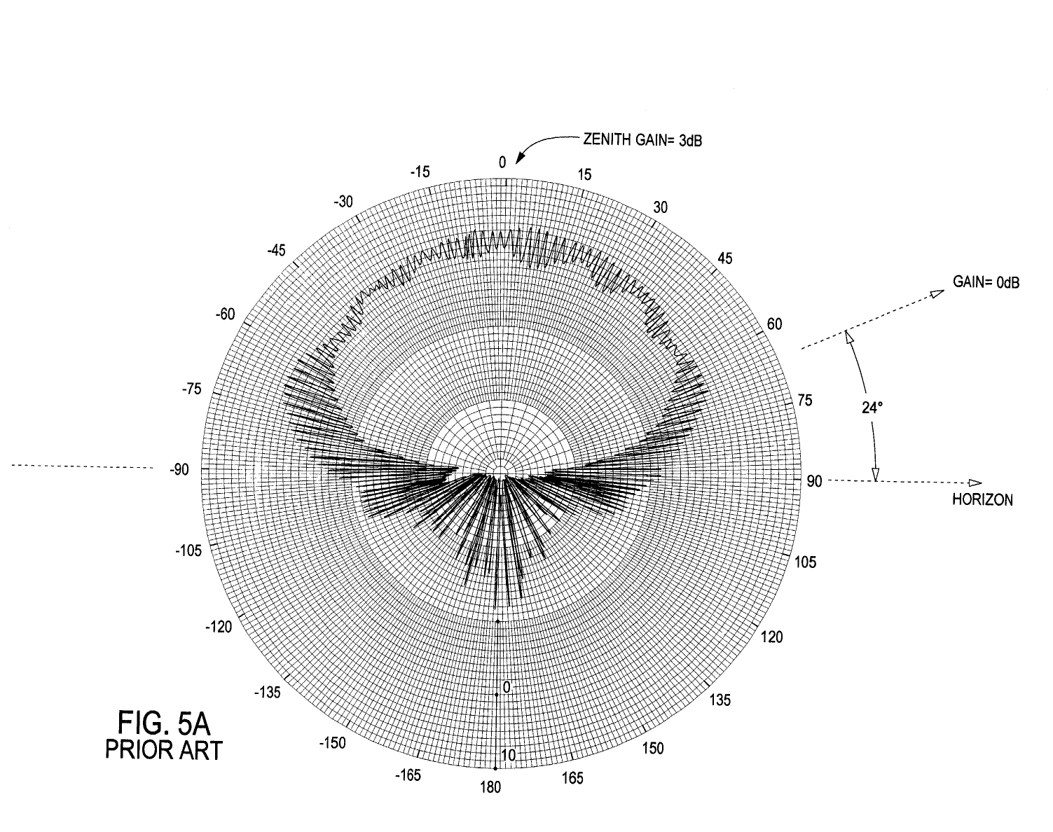

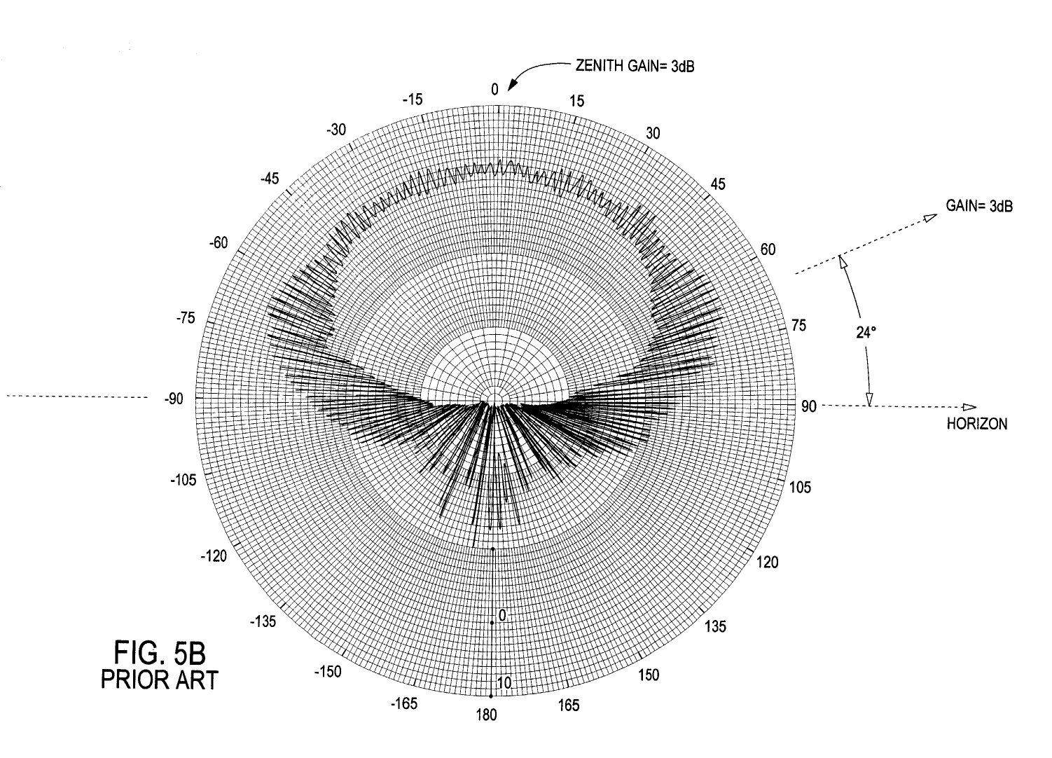

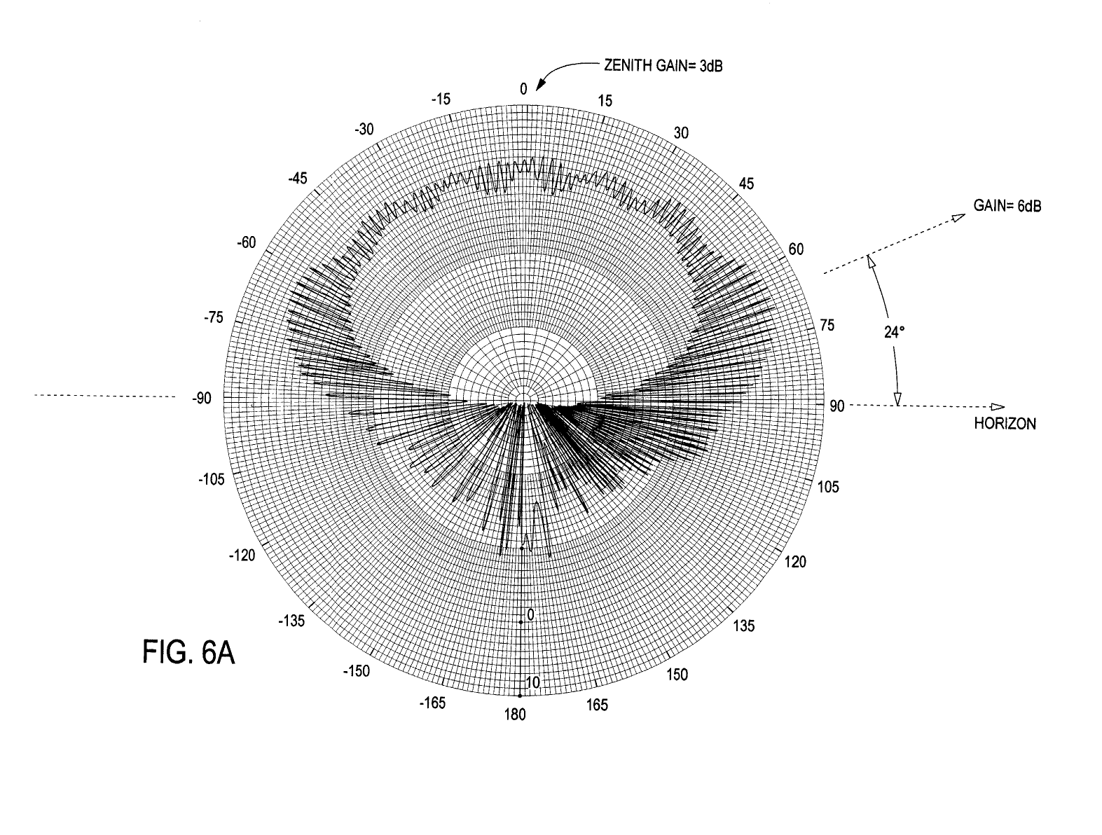

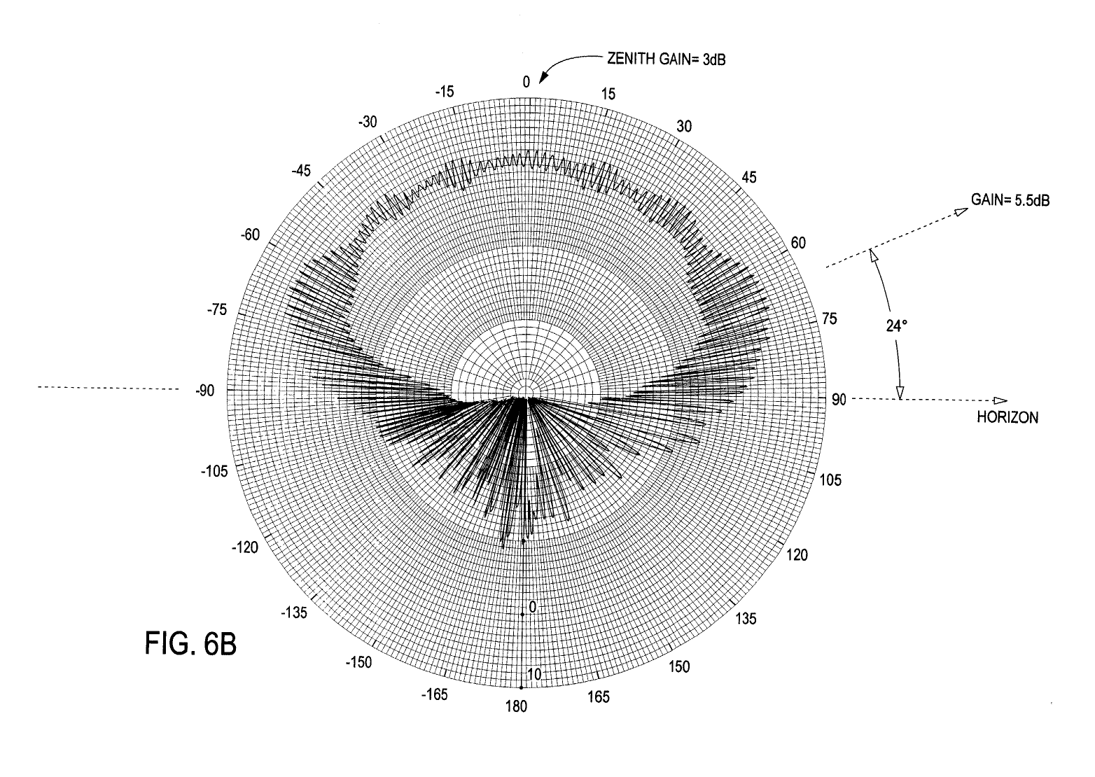

For the purposes of illustrating the increased gain at low angles which is achieved by the present invention, FIGS. 5A, 5B, 6A and 6B are provided and will be described. FIGS. 5A and 5B are respective examples of “pitch” and “roll” graphs illustrating the radiation patterns of the conventional microstrip antenna of FIG. 1. FIGS. 6A and 6B are respective examples of “pitch” and “roll” graphs illustrating the radiation patterns of the microstrip antenna of FIG. 2A according to the present invention. Pitch and roll graphs represent different planes of the radiation patterns and are typically used to evaluate the performance characteristics of antennas.

By comparing the pitch graph shown in FIG. 5A for a conventional microstrip antenna (without any dielectric lens or raised ground plane) against the pitch graph shown in FIG. 6A for the microstrip antenna 100 (with the dielectric lens and the raised ground plane), a significant increase in the radiation gain at low angles can be clearly seen. For example, at the low angle of 24° from the horizon, the gain of 0 Dai is achieved by the conventional microstrip antenna as illustrated in FIG. 5A. This gain is increased by about 6 dB when the microstrip antenna of the present invention is used, as shown in FIG. 6A. This is a significant increase in gain since an increase in 3 dB (logarithm scale) is the same as doubling the number in a linear scale. These graphs also show that the gain at the zenith (90° from the horizon) is maintained at 3 dB with the use of the microstrip antenna of the present invention.

Similarly, the roll graphs demonstrate a significant increase in the gain at low angles when the microstrip antenna of the present invention is used. For example, at the low angle of 24° from the horizon, the gain of 3 dB is achieved by the conventional microstrip antenna as illustrated in FIG. 5B. This gain is increased significantly to 5.5 dB (an increase of about 2.5 dB) when the microstrip antenna of the present invention is used, as shown in FIG. 6B. These graphs also show that the gain at the zenith is maintained at 3 dB with the use of the microstrip antenna of the present invention.

Accordingly, the present invention provides improved microstrip antennas that offer high gain both at the zenith and at low angles by using a dielectric lens encapsulating the patch in conjunction with a raised ground plane. The antennas of the present invention can be used in any communications system, device or environment. Furthermore, the space created between the raised ground plane and the flat ground plane can be used to compactly incorporate therein other electronics or elements as needed by the microstrip antenna or the system using the microstrip antenna.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A microstrip antenna comprising:
a first conductive ground plane;
a dielectric substrate disposed on the ground plane;
a patch disposed on the dielectric substrate;
feed means for electrically feeding the patch; and
a dielectric lens for encapsulating at least a portion of the patch to increase radiation gain at low angles.

2. The microstrip antenna of claim 1, further comprising:
a second ground plane formed between the dielectric substrate and the first ground plane for raising the patch and further increasing the radiation gain at the low angles.

3. The microstrip antenna of claim 2, wherein the first and second ground planes are disposed such that a space is created between the first and second ground planes for providing additional elements therein.

4. The microstrip antenna of claim 2, wherein the dielectric lens covers completely the patch and the dielectric substrate.

5. The microstrip antenna of claim 2, further comprising:
an air gap disposed between the patch and the dielectric lens.

6. The microstrip antenna of claim 2, wherein the second ground plane includes at least one slant portion, and a flat portion for disposing thereon the patch, and wherein the first ground plane is entirely flat.

7. The microstrip antenna of claim 2, wherein the dielectric lens has a dome configuration.

8. The microstrip antenna of claim 1, wherein the first ground plane is flat and the dielectric substrate is disposed directly on the first ground plane.

9. The microstrip antenna of claim 1, further comprising:
an additional antenna element disposed through the patch, the dielectric substrate, the ground plane, and the dielectric lens.

10. The microstrip antenna of claim 9, wherein the additional antenna element is a monopole.

11. The microstrip antenna of claim 10, further comprising:
a dielectric cap disposed around the monopole.

12. The microstrip antenna of claim 2, further comprising:
a monopole disposed through the patch, the dielectric substrate, the second ground plane and the dielectric lens; and
a dielectric cap surrounding the monopole,
whereby a dual-function antenna is provided.

13. The microstrip antenna of claim 12, further comprising:
an air gap disposed between the patch and the dielectric lens.

14. The microstrip antenna of claim 1, wherein the feed means includes a feed pin disposed through the patch, the dielectric substrate and the ground plane.

15. A method of providing a microstrip antenna, comprising the steps of:
providing a first conductive ground plane;
providing a dielectric substrate on the ground plane;
providing a patch on the dielectric substrate;
providing feed means for feeding the patch; and
providing a dielectric lens encapsulating at least a portion of the patch to increase radiation gain at low angles.

16. The method of claim 15, further comprising the step of:
providing a second conductive ground plane between the dielectric substrate and the first ground plane for raising the patch and further increasing the radiation gain at low angles.

17. The method of claim 16, wherein the second ground plane includes at least one slant portion, and a flat portion for disposing thereon the patch, and wherein the first ground plane is entirely flat.

18. The method of claim 15, wherein the first ground plane is entirely flat and the dielectric substrate is disposed directly on the first ground plane.

19. The method of claim 16, further comprising the step of:
providing an additional antenna element disposed through the patch, the dielectric substrate, the second ground plane, and the dielectric lens.

20. The method of claim 19, wherein the additional antenna element is a monopole.

21. The method of claim 19, further comprising the step of:
providing a dielectric cap disposed around the monopole.

22 The method of claim 19, further comprising the step of:
providing an air g gap between the patch and the dielectric lens.

23. The method of claim 15, wherein, in the step of providing the feed means, the feed means includes a feed pin disposed through the patch, the dielectric substrate and the ground plane.
